(19) United States
(12) Patent Application Publication
(10) Pub. No.: US 2006/0185125 A1
(43) Pub. Date: Aug. 24, 2006

(54) Support arm assembly with latching device

(75) Inventors: William S. Hansen II, Mettawa, IL (US); Charles E. Bullock, Waukegan, IL (US); Michael M. Grant, Crystal Lake, IL (US); Andre P. Paret, Kenosha, WI (US)

Correspondence Address: BRINKS HOFER GILSON & LIONE, P.O. BOX 10395, CHICAGO, IL, 60610, US

(73) Assignee: A.L. HANSEN MANUFACTURING CO.

(21) Appl. No.: 11/344,474

(22) Filed: Jan. 31, 2006

Related U.S. Application Data
(60) Provisional application No. 60/655,039, filed on Feb. 22, 2005.

(51) Int. Cl. E05D 11/10

(52) U.S. Cl. 16/321

(57) ABSTRACT

A support arm assembly includes a first link pivotally connected to a second link, a first latch component connected to the first link and a second latch component. The second latch component is engaged with the first latch component when the first and second links are in a first position, for example and without limitation when a lid connected thereto is moved to a closed position relative to a body component.

This application claims the benefit of U.S. Provisional Application No. 60/655,039, filed Feb. 22, 2005, the entire disclosure of which is hereby incorporated herein by reference.

### FIELD OF THE INVENTION

The present invention relates generally to a support arm, and in particular, to a support arm assembly having a latching device for securing the support arm in a latched position.

### BACKGROUND

Conventionally, lids or tops such as hoods, trunk lids or large container tops are provided with biasing elements that bias the lid or top from a closed position to an open position. One such application is that of a lid that covers a pick-up truck bed. It is desirable to provide such a lid with a biasing element that assists the user in lifting the lid from a closed to an open position, and that supports the lid in the open position. One linkage especially suited for supporting such a lid is disclosed for example in U.S. Pat. Nos. 6,041,548 and 6,212,827, both of which are assigned to A. L. Hansen Mfg. Co., the Assignee of the present application, the entire disclosures of which are hereby incorporated herein by reference.

Typically, an auxiliary latch or retention device is required to latch or secure the lid in a closed position. Such latches are typically separate from the support arm, and can be misplaced during shipping or assembly. In addition, such latches must be installed separately from the support arm, usually at a spaced apart location, which can be time consuming and require multiple adjustments.

### SUMMARY

The present invention is defined by the following claims, and nothing in this section should be considered to be a limitation on those claims. By way of introduction, the embodiment of a support arm assembly described below may be attached between any two elements that are being supported relative to one another. For example and without limitation, the support arm can be coupled between a lid and an enclosed compartment of a vehicle, such as a truck bed, to provide lifting forces tending to open and support the lid.

In one embodiment, a support arm assembly includes a first link pivotally connected to a second link, a first latch component connected to the first link and a second latch component. The second latch component is engaged with the first latch component when the first and second links are in a first position, for example and without limitation when a lid connected thereto is moved to a closed position relative to a body component. In one embodiment, the second latch component is further connected to the second link.

In another aspect, a method of supporting a lid in an open position relative to a body component and latching the lid in a closed position is also provided. In yet another aspect, a vehicle incorporating a support arm assembly with a latch is provided.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of a first embodiment of a support arm assembly.

FIG. 2 is a top view of the support arm assembly shown in FIG. 1 mounted to a body component and lid, both shown in partial cut-away.

FIG. 3 is a side view of the support arm assembly mounted to the body component and lid shown in FIG. 2.

FIG. 4 is an end view of the support arm assembly mounted to the body component and lid shown in FIG. 2.

FIG. 5 is a perspective view of the first and second latch components of the support arm assembly embodiment shown in FIG. 1.

FIG. 6 is a partial, side cross-sectional view of the support arm assembly shown in FIG. 1.

FIG. 7 is a side view of the first and second latch components and mounting bracket of the support arm assembly embodiment shown in FIG. 1.

FIG. 8 is a bottom view of a second embodiment of a support arm assembly without a biasing element in a closed position.

FIG. 9 is a second, side perspective view of the second embodiment of the support arm assembly without a biasing element shown in FIG. 8 in a partially open position.

FIG. 10 is a bottom, partial view of the partial perspective view of the second embodiment of the support arm assembly in a closed position.

FIG. 11 is a side view of the first and second latch components of the support arm assembly embodiment shown in FIG. 8.

FIG. 12 is a side view of a body component, lid and support assembly disposed between the lid and support assembly, with the lid in an open position.

FIG. 13 is a side view of the assembly shown in FIG. 12, with the lid in a closed position.

### DETAILED DESCRIPTION OF THE PRESENTLY PREFERRED EMBODIMENTS

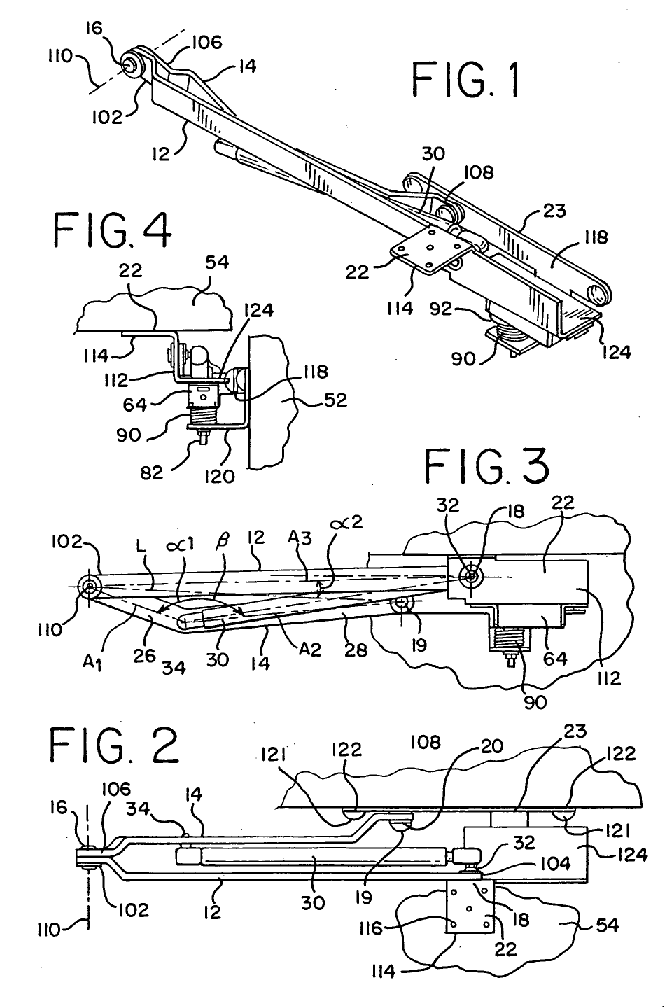

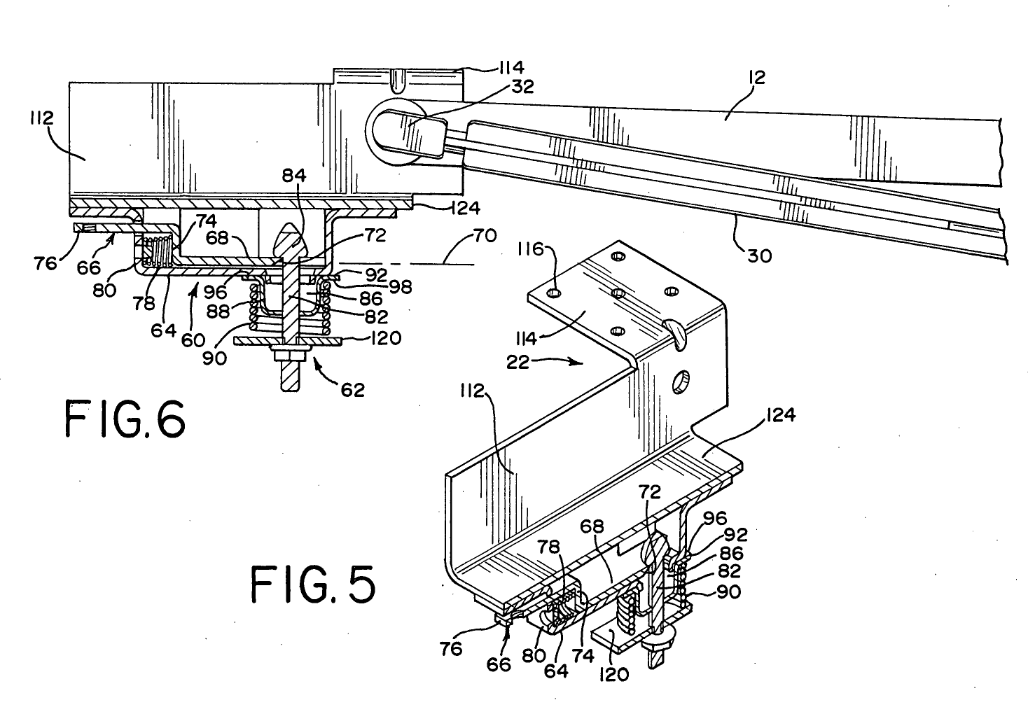

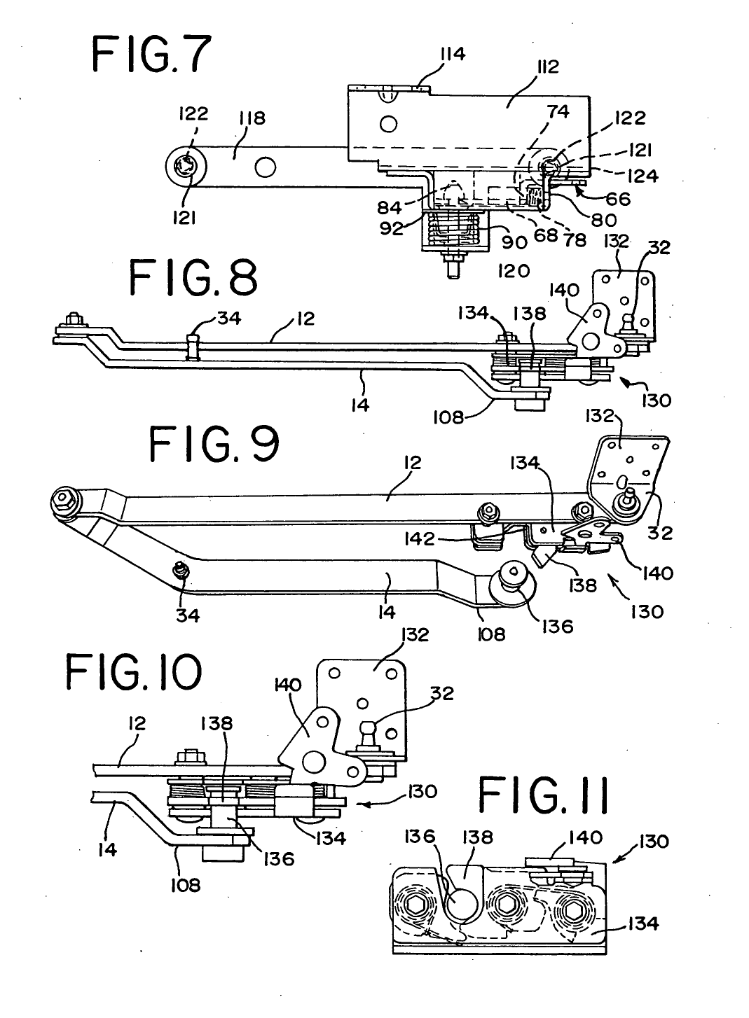

Turning now to the drawings, FIGS. 1-7 show one embodiment of the support arm assembly, which includes a support arm, a latch device and a pair of mounting brackets. Various embodiments of the support arm are disclosed in U.S. Pat. Nos. 6,041,548 and 6,212,827, both of which are assigned to A. L. Hansen Mfg. Co., the Assignee of the present application, the entire disclosures of which are hereby incorporated herein by reference. The support arm 10 includes the first and second rigid links 12, 14. The first link 12 has first and second ends 102, 104. The second link has first and second ends 106, 108. The first ends 102, 106 of the first and second links are pivotably interconnected at a pivot 16 with a pin or axle such that the links 12, 14 are free to rotate with respect to one another about the pivot axis 110 as shown in FIG. 2. The second end 108 of the first link includes an angled portion that jogs outwardly, while the first ends 102, 106 of the links are angled so as to jog inwardly, thereby forming a space between the first and second links.

As best shown in FIGS. 1, 3 and 12, the second link 14 includes a first portion 26 that extends to the pivot 16 and first end 106 and a second portion 28 that extends from the first portion to a second end 108. The first and second portions 26, 28 form an angle β relative to each other and are non-parallel. In one preferred embodiment, the angle β is about 154 degrees, and in various embodiments is between about 90 degrees and about 180 degrees.

A biasing element 30, which in one embodiment takes the form of a gas spring, is mounted to the first and second links 12, 14 by first and second joints 32, 34, respectively, forming first and second attachment locations. As shown in FIG. 2, the biasing element is disposed in the space between the first and second links. In a preferred embodiment, the first and second joints 32, 34 are both ball joints. The biasing element 30 biases the first and second joints 32, 34 away from one another. Other suitable biasing elements include without limitation extension coil springs, hydraulic cylinders, screw devices, and other extension devices.

As best shown in FIG. 3, the second link 14 defines a first axis A1 extending between the pivot axis 110 and the second joint 34 and a second axis A2 extending between the second joint 34 and the second mounting element at a pivot axis defined by a pin 19. The first and second axes A1, A2 form an obtuse angle α1 that faces the first link 12. The obtuse angle α1 is preferably greater than 135 degrees and more preferably about 154 degrees, and in one embodiment is the same as β. The angle between A1 and the axis between joint 34 and joint 32, when the lid is closed, is preferably about 151 degrees.

Because the axes A1, A2 are angled with respect to one another as shown in FIG. 3, the first and second joints 32, 34 are disposed on opposite sides of a line L extending between the pivot 16 and the second mounting element, and in particular the pivot axis defined by shaft 19. As shown in FIG. 3, the second joint 34 is positioned at an intermediate point along the second link 14 generally between the pivot 16 and the second mounting element pivot axis defined by shaft 19. Axis A3 extends between the pivot axis 110 and the axis defined by pin 18. The angle α2 formed between axis A3 and line L is less than the angle α1 formed between axis A1 and axis A3.

The first and second links 12, 14 can be formed from a main support element, for example a tubular structure. In other embodiments, the first and second links are made of a strap or web of material, or some other cross-section, such as an I-beam, C-channel, a circular or polygon shape (including for example and without limitation a hexagon or pentagon shape), or the links can formed as a solid bar or web, or other suitable structure. In one preferred embodiment, the tubular structure has a “rectangular” cross-section, which is meant to include a square cross-section where all sides have the substantially the same length and a structure where the sides have different lengths. Preferably, the links 12, 14 are made of a metal such as steel or aluminum, or of some other rigid material such as fiberglass or composites.

As shown in FIG. 2-4, 12 and 13, the support arm assembly 2 can be mounted to a vehicle 50, such as a pickup truck, including a body component 52, such as a truck bed 52 and a lid 54. In this exemplary application, the lid 54 is pivotably connected to the body component 52 at a hinge 56. The hinge can be configured as a simple hinge, or can include for example and without limitation a scissors mechanism as shown in FIGS. 12 and 13. The lid 54 can have a length, for example and without limitation, of six to eight feet. The biasing element 30 provides a biasing force tending to move the first and second joints 32, 34 away from one another, thereby tending to extend the support arm 10 to provide a lifting force tending to rotate the lid 54 about the hinge 56 to an open position. It should be understood of course, that the support arm can be used to move and support any two elements relative to each other, and is not limited to use with a truck bed and lid.

Referring to FIG. 3, a first mounting element 18 is secured to one end of the first link 12, and a second mounting element 20 is secured to one end of the second link. The term “mounting element” is intended broadly to encompass any suitable structure for securing the respective link to an adjacent structure. In one embodiment, the mounting element 18 takes the form of a shaft and the second mounting element takes the form of an opening 20, though other mounting elements can be used as explained below.

As best shown in FIGS. 1-7, 12 and 13, the first mounting element further includes a mounting bracket 22 pivotally secured to the end of the first link with the mounting element shaft 18 about an axis defined by the shaft 18. The second mounting element further includes a shaft 19 secured through opening 20 and a second bracket 23 pivotally secured to the second link 14 with the shaft 19.

As best shown in FIGS. 2-4, the first shaft 18 secures the first link 12 to the mounting bracket 22 such that the first link 12 is free to pivot with respect to the mounting bracket 22 about an axis defined by the first shaft 18. The bracket 22 includes a first support flange 112 pivotally connected to the link 12 and a second mounting flange 114 extending from the support flange 112 in a second direction and defining a mounting surface parallel to the pivot axis 110. The mounting flange 112 has a plurality of mounting holes 116 formed therethrough. The mounting flange 112 is attached to the truck lid 54 as shown in FIGS. 2-4. It should be understood that the bracket could be mounted to either side of the second link, and further that the mounting flange can extend in either direction.

The mounting bracket 23 includes a first support flange 118 pivotally connected to the second link 14 and a second mounting flange 120 extending from the support flange 118 and defining a mounting surface parallel to the pivot axis 110. One or both of the support flange 118 and the mounting flange 120 has a plurality of mounting holes 122 formed therethrough. One or both of the support flange 118 and the mounting flange 120 are attached to the body component 52 as shown in FIGS. 2-4 with fasteners 121. It should be understood that the bracket could be mounted to either side of the second link, and further that the mounting flange can extend in either direction. Of course, it should be understood that the first link can be secured to the truck bed with a mounting element and that the second link can be secured to the truck lid with a mounting element. It should be understood that the mounting member shafts 18 and 19 can be rotatably or fixedly mounted to the first and second links, and the mounting brackets 22, 23 can be fixedly or pivotally mounted to the mounting member shafts 18, 19.

Referring to FIGS. 1-7, the latch device 4 includes a first latch component 60 connected to the first link. The term “connected” means coupled thereto, whether directly or indirectly, for example with a mounting bracket, but does not include indirect coupling by way of a vehicle body component such as the truck bed. In this way, the support arm assembly is a self-contained unit, with all of the components thereof being interconnected such that the unit can be easily shipped and installed. It should be understood that in one embodiment, only one of the latch components is “connected” to the support arm assembly, i.e., one or the other of the latch components may not be “connected” to the support arm assembly, but rather is separately attached to the body component or lid so as to be engaged by the other latch component that is “connected” to the support arm assembly.

Referring to the embodiment of FIGS. 1-7, 12 and 13, the first latch component 60 includes a housing 64 having a lever or latch member 66 with a catch portion 68 lying in a first plane 70. The housing 64 is secured to a third mounting flange 124 extending from the mounting bracket 22 substantially parallel to the plane of flange 114. In one embodiment, the catch portion includes a downwardly directed tapered surface 72. The latch member includes a second force receiving portion 74 formed as a wall lying substantially perpendicular to the catch portion 68 and a third actuating portion 76 formed as a flange extending from the force-receiving portion out of the housing.

A biasing element 78, shown as a compression spring, is disposed between a wall 80 of the housing and the force-receiving portion 74 so as to bias the catch portion 68 in a first direction substantially parallel to the plane 70 lying parallel to flanges 114 and 124. The actuator (not shown), such as a handle, lever, button or other device well know in the art, which can be secured to the vehicle or lid so as to move the catch member in a second direction opposite the first direction against the force of the biasing element. The actuator can be secured tot eh actuator portion with a cable, rod, lever, or other device so as to move the portion 76. For example and without limitation, the actuating portion can be moved or actuated electronically by remote control using a solenoid or other power source, or by with the push button, handle, lever or other actuator connected for example and without limitation by a cable or rod.

The second latch component 62 is mounted to the flange 120 of the second mounting bracket 23. The second latch component includes a latch post 82 having a catch portion 84 formed by a head of the post. The post extends upwardly from the mounting flange 120. A cup 88 is disposed around the post and has an upper annular flange 92. A biasing element 90, shown as a compression spring, is disposed around the cup 88 and extends between the bottom 98 of the annular flange and the flange 120. The biasing element 90 biases the cup 88 in an upward direction such that the head of the post, or the catch portion 84, is disposed within the cylinder 86 of the cup when the latch device 62 is in a disengaged position.

In operation, the lid 54 is moved from an open position, shown in FIG. 12, to a closed position, shown in FIGS. 2-4 and 13. In the closed position, the bottom 64 of the latch component housing pushes against the upper surface 97 of the cup 88 member in opposition to the biasing force of the spring 90 such that the head 84 of the post is exposed outside of the interior cylindrical cavity 86. The head or catch portion 84, which has a curved or tapered surface, slides against the tapered surface 72 of the catch portion 68 of the latch member and moves the latch member 66 in the second direction in opposition to the biasing force of the biasing element 78. As the head or catch portion 84 slides past the catch portion 68, the catch portion 68 is biased in the first direction into an engaged position against the catch surface 84 of the post member so as to put the first and second latch components in an engaged, or latched position.

In the reverse sequence, the user actuates the latch member 66 by moving the actuator portion 76 with an actuator (not shown) in the second direction against the force of the biasing element 78 until the catch portion 68 is disengaged from the catch portion 84 of the post, wherein after the biasing element 90 pushes the cup 88, housing 64, mounting bracket 22 and lid 54 to a disengaged position wherein after the lid can be easily lifted to the open position. Preferably, the configuration of the latch, biasing element 30 and links 12, 14 cause the lid to pop up to an initial open position after the latch is released so as to form a gap between the bottom of the lid and the body component. In this way, the user can reach under the lid and lift it with the assistance of the biasing element 30 to a fully open position.

It should be understood that the positioning of the first and second latch components 60, 62 can be reversed, with the first latch component mounted to the second mounting bracket and thereby being connected to the second link and the second latch component being mounted to the first mounting bracket and thereby being connected to the first link. In other embodiments, one of the first or second latch components is secured directly to the lid or body component, and is not “connected” to the support arm assembly.

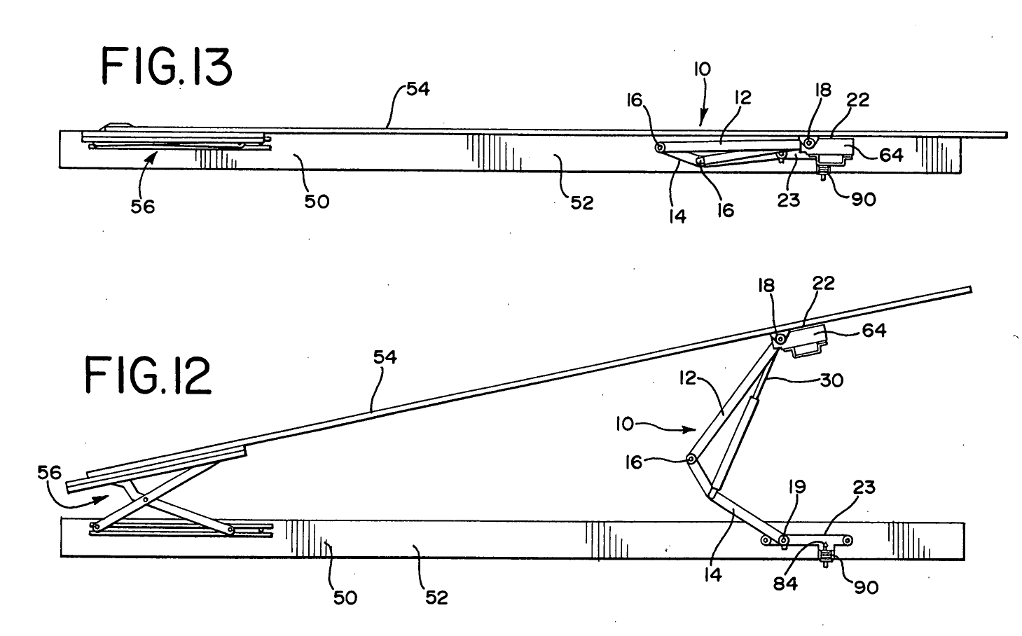

Referring to the embodiment of FIGS. 8-11, the orientation of the first link 12 is reversed relative to the second link 14 by rotating the second link 180° about a longitudinal (lengthwise) axis such that the first and second links 12, 14 are nested rather than being opposed. In this embodiment, the mounting arrangements, or ball joints 32, 34, extend in the same direction from the first and second links as shown in FIG. 8, rather than being opposed as shown in the embodiment of FIG. 2.

As shown in FIGS. 8-10, a latch device 130 is directly connected to and between the first and second links. A mounting bracket 132 secures the first link 12 to the lid 54, although it can be secured to the body component in an alternative embodiment. The end 108 of the first link 14 can be directly secured to the body component 52, or indirectly with a mounting bracket (not shown). Alternatively, the second link can be secured to the lid with the first link secured to the body component.

In one embodiment, the latch device 130 is configured as a rotary latch. One suitable rotary latch is the #450 L.H. 1-PT. rotary latch available from A. L. Hansen Mfg. Co., the Assignee of the present application. The latch device includes a first latch component 134 configured as a rotary latch, and a second latch component configured as a cylindrical strike member 136 or pin.

The first latch component 134 is mounted to a side of the first link with a latch-receiving opening 142 facing towards the second link. The first latch component 134 includes a rotary actuator 140, which is connected to a user interface actuator (not shown) such as a handle, lever, button or other known device. The second latch component 136 is mounted to the second link 14, for example at the second end 108 of the second link. In operation, as the first link 12 is moved toward the second link 14, the second latch component 136 is received in the latch-receiving opening 142 and moves a catch portion 138 into engagement therewith so as to latch the second link 14 to the first link 12 as the lid 54 is moved to a closed position relative to the body component. To release the latch device 130, the user actuates or rotates the actuator 140 and releases the catch member 138, which is biased to an open position, such that the latch component 136 can be removed from the opening 142 and such that the second link 14 can be moved relative to the first link 12. As with the first latch device, the latch components can be reversed, with the first latch component 134 secured to the second link 14 and the second latch component 136 secured to the first link 12. In addition, one or the other of the first or second latch components can be secured directly to the lid or body component.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A support arm assembly comprising:
a first link comprising first and second ends and a first attachment location adapted to support a biasing element;
a second link comprising first and second ends and a second attachment location adapted to support the biasing element, wherein said first end of said second link is pivotally mounted to said first end of said first link about a first pivot axis, wherein said first link is pivotable relative to said second link about said first pivot axis, and wherein said second end of said second link is pivotable about a second pivot axis, wherein said first and second links are pivotable between first and second positions as said first link pivots relative to said second link about said first pivot axis and as said second link pivots about said second pivot axis;
a first latch component connected to one of said first or second links; and
a second latch component engaged with said first latch component when said first and second links are in said first position, and wherein said second latch component is disengaged with said first latch component when said first and second links are in said second position.

2. The support arm assembly of claim 1 further comprising a biasing element connected between said first and second attachment locations.

3. The support arm assembly of claim 2 wherein one of said first and second links is connected to a vehicle body component and the other of said first and second links is connected to a lid.

4. The support arm assembly of claim 1 wherein said first latch component is connected to said first link and said second latch component is connected to said second link.

5. The support arm assembly of claim 1 wherein said second end of said second link is pivotally connected to a mounting bracket about said second pivot axis.

6. The support arm assembly of claim 5 wherein said second latch component is connected to said mounting bracket.

7. The support arm assembly of claim 1 wherein said first latch component comprises a catch member, and wherein said second latch component comprises a second catch member, wherein at least one or both of said first or second catch members is moveable between an engaged and a disengaged position.

8. The support arm assembly of claim 7 wherein said at least one or both of said first and second catch members is biased towards said engaged position with a biasing element.

9. The support arm assembly of claim 1 wherein one of said first or second latch components comprises a strike element and the other of said first or second latch components comprises a rotary latch having a catch member moveable between an engaged position wherein said catch member prevents movement of said strike element and a disengaged position wherein said catch member permits movement of said strike element.

10. The support arm assembly of claim 1 wherein said second link comprises a first portion and a second portion extending from said first portion, wherein said first and second portions are non-parallel, said first and second portions defining first and second ends of said second link respectively.

11. The support arm assembly of claim 1 wherein said second end of said first link is pivotally connected to a mounting bracket about a third pivot axis.

12. The support arm assembly of claim 12 wherein said first latch component is connected to said mounting bracket.

13. A method of supporting a lid in an open position relative to a body component and latching the lid in a closed position, the method comprising:
providing said lid moveably connected to said body component;
providing a support arm assembly comprising:
a first link pivotally connected to said lid;
a second link pivotally connected to said first link and pivotally connected to said body component;
a biasing element extending between and connected to said first and second links; and
a first latch component connected to one of said first or second links;
moving said lid relative to said body component from a open position to a closed position;
pivoting said first link relative to said second link; and
engaging said first latch component with a second latch component as said lid is moved from said open position to said closed position relative to said body component.

14. The method of claim 13 wherein said first latch component is connected to said first link and said second latch component is connected to said second link.

15. The method of claim 14 further comprising providing a mounting bracket connected to said body component, wherein said second link is pivotally connected to said mounting bracket and said second latch component is connected to said mounting bracket.

16. A vehicle comprising:
a body component;
a lid moveable relative to said body component between an open position and a closed position;
a support arm assembly comprising:
a first link pivotally connected to said lid;
a second link pivotally connected to said first link and pivotally connected to said body component;
a biasing element extending between and connected to said first and second links; and
a first latch component connected to said first link; and
a second latch component connected to said second link, wherein said second latch component is engaged with said first latch component when said lid is moved to said closed position so as to prevent relative movement between said lid and said body component.

17. The vehicle of claim 16 further comprising a mounting bracket connected to said body component, wherein said second link is pivotally connected to said mounting bracket and said second latch component is connected to said mounting bracket.

18. The vehicle of claim 16 wherein said second latch component is mounted directly to and is moveable with said second link.

19. The vehicle of claim 16 further comprising a mounting bracket connected to said lid, wherein said first link is pivotally connected to said mounting bracket and said first latch component is connected to said mounting bracket.

20. The vehicle of claim 16 wherein said first latch component is mounted directly to said first link.
